(19) United States
(12) Patent Application Publication
(10) Pub. No.: US 2004/0268301 A1
(43) Pub. Date: Dec. 30, 2004

(54) Adding new compiler methods to an integrated development environment

(76) Inventor: Yaakov Kaston, Ramla (IL)

Correspondence Address: DANIEL J SWIRSKY, PO BOX 2345, BEIT SHEMESH, 99544, IL

(21) Appl. No.: 10/462,038

(22) Filed: Jun. 16, 2003

(51) Int. Cl. G06F 9/44; G06F 9/45; G06F 9/46

(52) U.S. Cl. 717/108; 717/118; 717/116; 717/140; 717/148; 719/310; 719/328

(57) ABSTRACT

Adding new compilers and methods to an integrated development environment (IDE), such as Microsoft's Visual Studio .Net®, is disclosed. This enables a programmer to develop, build and execute applications written in programming languages supported by new compilers, or new methods thereof, using an IDE such as the Visual Studio .Net framework. The integration of new compilers in the Visual Studio .Net is accomplished by using a COM interface wrapping technique further disclosed by the present invention.

### FIELD OF THE INVENTION

The present invention relates generally to adding new compiler methods to an integrated development environment, and more particularly, to adding new compilers to Microsoft Visual Studio .Net, while modifying objects based on the component object model (COM).

### BACKGROUND OF THE INVENTION

The Microsoft® .NET® framework is a new platform for building integrated, service-oriented, applications to meet the needs of today's and future Internet businesses. The .Net platform allows developers to take better advantage of technologies than any earlier Microsoft platform. Specifically, the .NET platform provides for code reuse, code specialization, resource management, multi-language development, security, deployment, and administration. The .Net platform allows different programming languages to be integrated with one another. For example, it is possible to create a class in C++ that is derived from a class implemented in Visual Basic. The programming languages supported by the .Net platform include, but are not limited to, C++ with managed extensions, C-sharp (C#), Visual Basic, Pascal, Cobol, Java, JScript and many others. The source code written in these languages requires the common language runtime (CLR) engine in order to execute.

A .Net application is developed using developer tools, such as Microsoft Visual Studio for .NET (hereinafter, the “VS .Net”), which provides an integrated development environment (IDE) for maximizing programmer productivity with the .NET framework. The VS .Net allows a programmer to create, compile, debug and execute a .Net application using one or a combination of the above mentioned programming languages. The VS .Net framework provides developers with a unified, object-oriented, hierarchical, and extensible set of class libraries. By creating a common set of Applications Programming Interfaces (API's) across all programming languages, the common language runtime enables cross-language inheritance, error handling and debugging. All programming languages have similar access to the framework and developers are free to choose the language to use. Furthermore, the VS .Net includes features, such as property pages, namespaces and project integration that simplify software deployment.

The VS .Net compilers are integrated to the IDE using component object models (COMs). COM is one model that defines architecture for building objects and, in particular, defines the polymorphism between objects. Polymorphism is the ability for different objects to behave differently for the same message. COM is used extensively and its details are well known to those skilled in the art. Currently, COM provides for certain communications and operations between objects. Objects used in a COM environment must conform to the COM definitions and rules.

The QueryInterface call is the primary mechanism provided by COM for determining which features an object supports. The function of an object is accessed via one or more interfaces designed to expose that functionality. QueryInterface is used to determine what interfaces are available and hence the functionality an object supports. QueryInterface is the only way to get the necessary pointer to an interface of an object.

A third party application can access the COM object though its interface, but such application cannot change the COM object behavior nor inherit its implementation. Hence, a programmer cannot change the way the third party application interacts with the COM object.

Recent prior art includes U.S. Pat. No. 6,304,918, issued on October, 2001, by Fraley, et al, which discloses an object interface control system that provides a mechanism for identifying the functionality available at an interface separately from the interface itself A COM implementation provides a new function call named QueryService which is similar to the existing QueryInterface function call. Services are defined which include a set of functionality. The set of functionality for a service is expressed through a family of interfaces.

U.S. Pat. No. 5,710,925, issued on January, 1998, by Leach, et al, teaches a method and system for aggregating objects within a computer system are provided. The method aggregates an enclosed object within an enclosing object. The enclosed object has an object management interface and an external interface, while the enclosing object has a controlling object management interface. The controlling object management interface and the external interface of the enclosed object have query function members for receiving an identifier of an interface and for returning a reference to the identified interface.

Thus, there remains a need to provide a solution that would allow a third party application to replace or to add new methods to already implemented COM object. Such a solution would simplify the integration of new compilers in the VS .Net.

### SUMMARY OF THE INVENTION

Accordingly, it is a principal object of the present invention to provide a solution that would allow a third party application to replace or to add new methods to already implemented COM object.

It is another object of the present invention to provide a solution which would simplify the integration of new compilers in the Visual Studio® .Net.

It is a further object of the present invention to provides a method and software product for integrating newly developed compilers and methods in an integrated development environment (IDE), such as the Visual Studio for .Net.

A method is disclosed for adding at least a Java compiler to an integrated development environment (IDE), wherein the method enables a programmer to develop a software application written in any programming language supported by the IDE and to execute the software application on at least a Java runtime environment, wherein the Java compiler is capable of compiling Microsoft intermediate language (MSIL) bytecodes into Java bytecodes, the method begins with entering a deployment programming language and a source programming language of the software application. Further steps include replacing each original deployment function of the IDE with a new deployment function of the Java compiler and building the software application.

### BRIEF DESCRIPTION OF THE DRAWINGS

For a better understanding of the invention in regard to the embodiments thereof, reference is made to the accompanying drawings and description, in which like numerals designate corresponding elements or sections throughout, and in which:

FIG. 1 is an exemplary flowchart for integrating a newly developed compiler in the VS .Net framework, constructed in accordance with one embodiment of the present invention;

FIG. 2 is an exemplary memory layout of a COM object that implements one interface;

FIG. 3 is a detailed flowchart describing the COM interfaces wrapping, constructed in accordance with one embodiment of the present invention; and

FIG. 4 is a detailed flowchart of the execution of the generic wrapper procedure, constructed in accordance with one embodiment of the present invention.

### DETAILED DESCRIPTION OF THE INVENTION

The invention will now be described in connection with certain preferred embodiments with reference to the following illustrative figures so that it may be more fully understood. References to like numbers indicate like components in all of the figures.

The present invention provides a method and software product for integrating newly developed compilers and methods in an integrated development environment (IDE), such as the Visual Studio® (VS) for .Net®. This would enable a programmer to develop, build and execute applications written in the programming language supported by the new compiler through the VS .Net framework. Furthermore, the present invention adapts the new compiler to support features, such class libraries, property pages and namespaces introduce in the VS .Net framework. The integration of new compilers in the VS .Net is accomplished by using a COM interface wrapping technique disclosed by the present invention.

The present invention is particularly designed to support the integration of compilers that compile .Net applications to executable code that can be executed on a runtime environment different from the common language runtime (CLR), hereinafter the “IL2J” compilers. The runtime environment may be the Java virtual machine (JVM), Unix platform, Linux platform and the like. An example for such IL2J compiler is disclosed in U.S. patent application Ser. No. 10/437,518 entitled “Compiler and Software Product For Compiling Intermediate Language Bytecodes Into Java Bytecodes” assigned to common assignee, and which is hereby incorporated for all that it contains. This compiler compiles .Net assembly files, generated by one of the compiler embedded in the VS .Net, into the Java bytecodes, which are executed on a JVM. This, for example, would allow software developers to develop Web applications in the Visual Basic language and execute those applications on a JVM. Hence, those WEB applications can be executed on a wide range of computers, ranging from small devices, e.g., personal digital assistances (PDA's) and cell phones up to supercomputers. For that reason, the integrated VS .Net provides software developers with the ability to develop and design enhanced software applications.

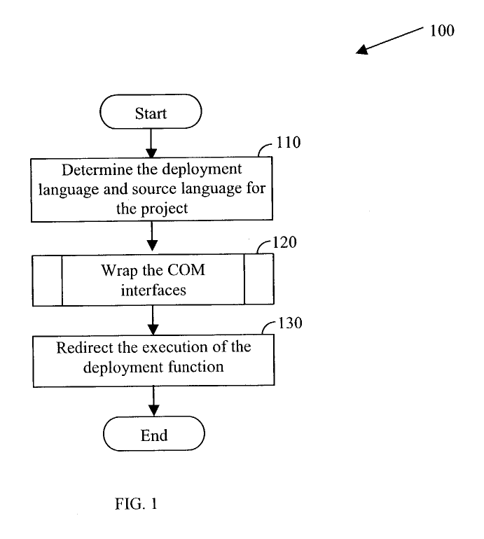

Reference is now made to FIG. 1, where an exemplary flowchart 100 describes the method for enabling the operation of the IL2J compiler in the VS .Net framework, in accordance with one embodiment of the present invention. The IL2J compiler produces Java executable files that can be executed on a runtime environment different from CLR. As discussed above the VS .Net includes a plurality of compilers each targeted to a different programming language supported by the .Net platform. The method replaces the execution of the deployment functions of the .Net compilers with the execution of the deployment functions of the IL2J compiler. This allows the programmer to write its application using the programming languages currently supported by the .Net framework or programming languages that would be added to the .Net platform.

At step 110, the target deployment language, i.e., Java programming language is determined. The source language, i.e., the language in which the source code is written is also determined. The source language may be one of the programming languages supported by the .Net framework. Generally, the programmer sets the source language and the target deployment language when creating a new project, e.g., through a “New Project” dialog box.

At step 120, the COM interfaces, for each COM object defined in the source language package, are wrapped. The COM objects in the source language package define the functionality of the compiler which is targeted to the selected source programming language. For example, if the selected source language is C-sharp (C#), then each COM interface defined in the C# package is wrapped, as described in greater detail below, to enable the execution of the new compiler's deployment functions, instead of the C# compiler's deployment functions. The COM wrapping provides a generic mechanism for redirecting the execution of the compiler functions. That is, if a new programming language is added to the VS .Net framework, then the Java compiler may be easily adapted to support this new language.

At step 130, as the programmer requires deployment of the application, the IL2J compiler executes its deployment functions. The deployment functions are operations performed by the integrated VS .Net to allow the generation of a correct executable code and subsequent execution of this code. The deployment functions include, but are not limited to, build, run, debug, and compile. Generally, after the build stage, the programmer may run or debug the program, and as a result the Java class libraries are loaded to the VS .Net.

The integrated VS .Net, i.e., the VS .Net including the Java compiler, further allows a programmer to define and use features, such as reference file, property pages and namespaces introduced in the VS .Net framework.

The present invention handles these and other features as follows:

The integrated VS .Net includes the standard namespaces of the deployment runtime component, e.g., Java to platform enterprise edition (J2EE) and Java to platform standard edition (J2SE) for the Java runtime environment. The namespaces are presented to the programmer. In general, namespaces are used as an organizational system, i.e., a system for presenting program components that are exposed to other programs and giving the programmer an overview of the runtime environment. A namespace is a name that defines the scope for one or more class, each class relates to a single namespace defined in the deployment runtime environment. A namespace is organized as a tree structure. The namespaces are added to the integrated VS .Net as the programmer defines a new project thorough the “New Project” dialog box.

The integrated VS .Net allows a programmer to add a reference to a Java reference file, as well as a reference to a COM object and Enterprise Java beans (EJB) object. The programmer may add the reference file through the “Add Reference File” dialog box. A Java reference file defines software components to be used by the deployment runtime environment. As a result, the integrated VS .Net converts the Java reference file is into a .Net stub file and the reference to the Java reference file is replaced with reference to the .Net stub file. A stub file is an assembly file that includes classes that can be executed by the .Net platform. The conversion of the reference file into a stub file is performed through the following steps:

analyzing the reference file;

changing software mechanisms unique to the Java language to their appropriate representation in the source language; and

converting the classes in the reference file into a .Net assembly file.

The generated assembly files are added to the project and cached for further uses. In addition, each COM object and EJB object added to the project is converted to a class that aggregates the methods defined in the COM and the EJB objects. The aggregating class would allow a developer to use the COM and EJB object in the .Net framework.

The programmer may set the properties of the Java compiler to the VS .Net through the “Property Pages” dialog box. Through these properties the programmer may change the compiler behavior for commands, such as build, debug, execute, as well as the behavior for the project development and optimizations.

It should be noted by a person skilled in the art that the method described above may be embodied as an independent software application or as software plug-in for Microsoft's Visual Studio .Net. It should be further noted that a person skilled in the art could easily adapt the described herein to add to the VS .Net compilers other than the IL2J compiler.

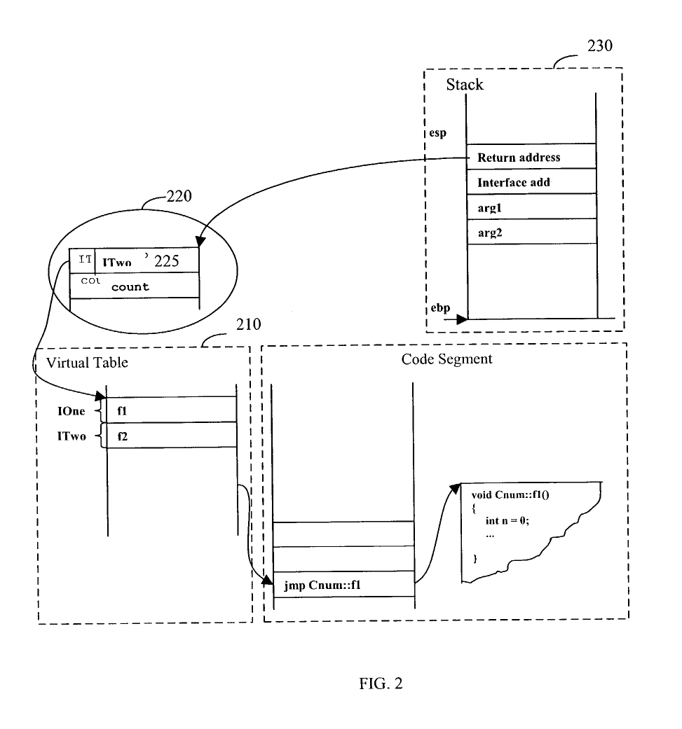

The COM interface wrapping technique provides an efficient way to replace or to add new methods to already implemented COM object. The wrapping technique replaces the calls to the method implemented by COM interface with calls to methods implemented by the new compiler, e.g., the IL2J compiler. As mentioned above, the COM interface is accessible through the QueryInterface call. The COM interfaces are implemented as virtual tables, a single virtual table for each COM interface. Each COM object implements at least one interface and maintains a single virtual table pointer per interface (VTP). The VTP points to the virtual table that contains the COM interface and its methods. Each VTP points to single virtual table, i.e., COM interface. The virtual tables are static, i.e., there is no change during runtime and they are used at run time to access the data members and the methods of the COM object. FIG. 2 is an exemplary memory layout of a COM object that implements one interface

FIG. 2 shows an instance of a COM object 220 of type “Cnum.” Object 220 is an instance of the class “Cnum.” The COM object implements the interface “ITwo.” “ITwo” specifies the name of the interface. Object 220 includes an integer member “count” and a VTP 225 that points to virtual table 210. The “ITwo” interface declares the method “f2” and extends the interface “IOne.” The “IOne” interface declares the method “f1”, thus “f1” may be called either through interface “ITwo” or through interface “IOne.” In view of the fact that the “ITwo” interface extends the “IOne” interface, virtual table 210 includes both “IOne” and “ITwo” interfaces. The entry of virtual table 210, that includes the method “f1,” does not point directly to the function's code, but rather to a “jump” directive that points to the function's code. The same is true for each function or method implemented in the COM interface. When a method is called through the interface, the interface address is pushed on stack 230. If the method is declared in more than one interface, the address of the first interface that declares this method is pushed on stack 230. Stack 230 further includes the return address, i.e., the address to return to after the function execution is ended, as well as the method arguments.

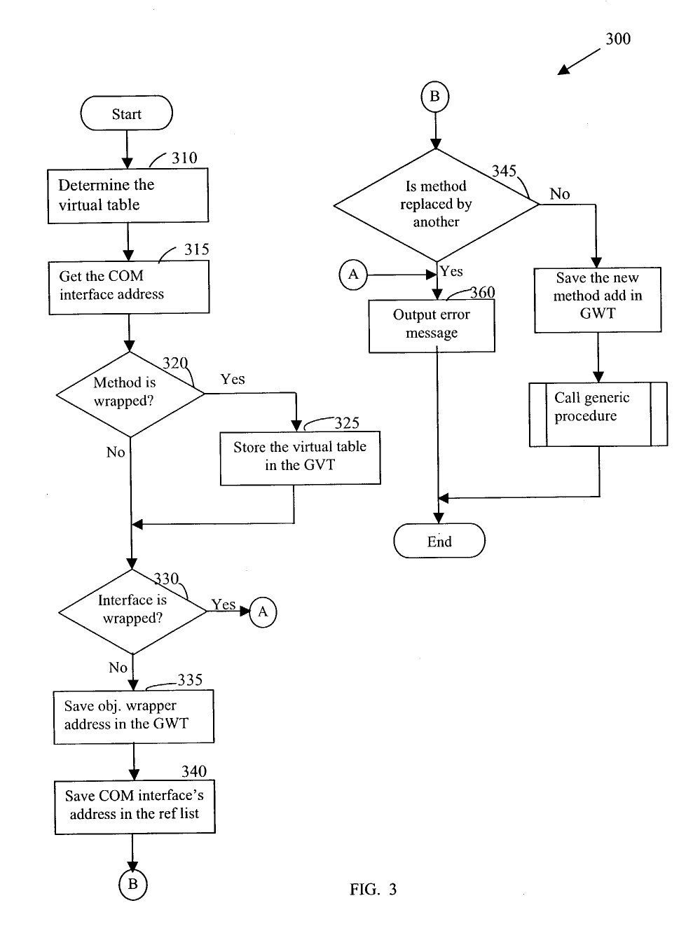

FIG. 3 is a detailed flowchart describing the COM interfaces wrapping, constructed in accordance with one embodiment of the present invention. This process wraps the COM interface's methods needed to be replaced by the new compiler's methods. As a result, the new compiler is capable of executing its own methods or functions required to compile, debug, or execute the application.

The following data structures are used to wrap the COM interface: global wrappers table (GWT), global virtual table (GVT) and interface list. The GWT includes, for each wrapped interface, the address of the wrapper object, i.e., the object that is allocated for wrapping a selected COM interface, and pointers for each new method that replaces the original method in exemplary virtual table 210. The GVT includes, for each virtual table, the pointers to the original methods. The interface list includes the COM interface address for each wrapped COM interface. The wrapping process begins when the COM interfaces name, e.g., “ITwo,” and the method to be replaced, e.g. “f2,” are received as an input.

At step 310, exemplary virtual table 210, and the order of the methods within virtual table 210 are determined. For each method a slot number is assigned, e.g., the methods “f1” and “f2” are assigned to slot numbers 0 and 1 respectively. At step 315, the address of the requested COM interface is obtained using the QueryInterface call. At step 320, a check is performed to determine whether it is the first time the requested method is wrapped, by checking if the GVT includes a NULL value. If so, at step 325 the pointer to this method, i.e., the original method, is stored in the GVT. An affirmative answer may result if the COM interface was already wrapped by a different instance object of the COM. Otherwise, execution continues with step 330, where it is determined if the COM interface is already wrapped by another wrapper object. If so, an error message is reported at step 360 and the execution is terminated, since the COM interface is also wrapped by another wrapper object. Otherwise, execution continues with step 335 where the address of the currently allocated wrapper object is saved in the GWT.

At step 340, the COM interface address, obtained at step 310, is saved in the interface list. At step 345, a check is performed to determine if the original method was already replaced by another method. This is done, by checking if the entry designated by the slot number in the GWT is empty, i.e., has a NULL value. If step 345 yields a negative answer, then at step 350 the address of the new method is saved in the GWT. At step 355, the entry in virtual table 210, e.g., f1, that includes the call to the original method, is replaced with a call to a generic wrapper procedure, which in turn will upload the new method at runtime. The generic wrapper procedure is described in greater detail below. If step 345 yields an affirmative answer, then at step 360 an error message is generated and the execution is terminated, as the original method cannot be replace by two different methods.

It should be noted that the new method may call and execute the original method. This is performed by:

accessing the interface list;

fetching the COM interface address; and

using the COM interface address fetching the original method's address from the GVT. Now, the new method jumps to the retrieved address using the “jump” directive.

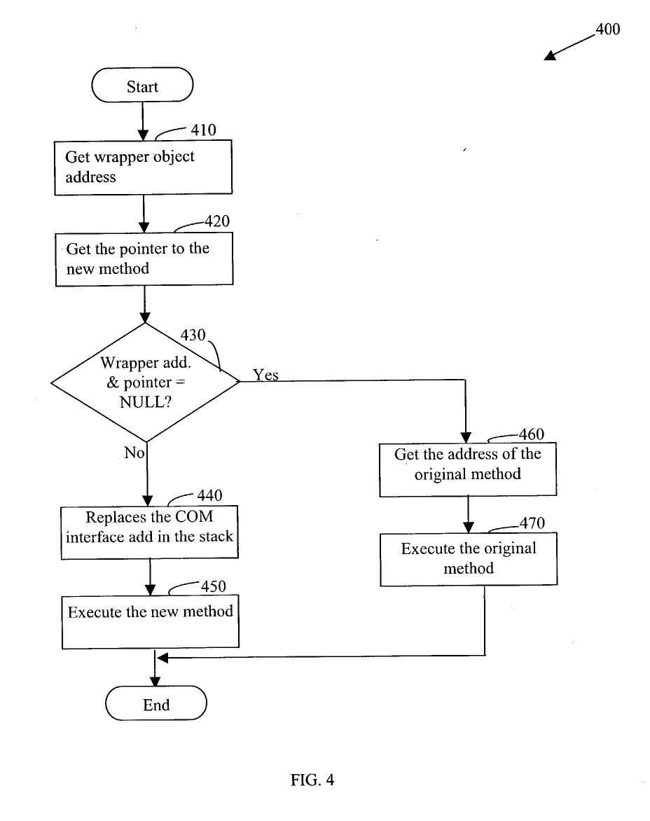

FIG. 4 is a detailed flowchart 400 of the execution of the generic wrapper procedure, constructed in accordance with one embodiment of the present invention. At step 410, the address for the wrapper object used to wrap the COM interface is obtained from the GWT. At step 420 the pointer pointing to the new method is retrieved from the GWT. At step 430, the values received at steps 410 and 420 are both compared to a NULL value. If the comparison result is negative, then execution continues at step 440, where the address of the COM interface in exemplary stack 230 is replaced with the wrapper object address.

At step 450 the execution continues from the location of the new method by using the “jump” directive. The procedure uses a “jump” directive and not a “call” directive to ensure that the stack's content does not be change. If the comparison at step 430 results in an affirmative answer, then at 460 the address of the original method is obtained from the GVT, and at step 470 the original method is executed. Steps 460 and 470 are applied when an instance object, which does not request the COM interface wrapping, calls the original method. Such case is permitted, since the virtual tables are shared among all the instance objects of the same COM type. Hence, no matter which instance object calls the original method, the generic wrapper is executed. Therefore, in order to avoid situations where the new method is executed rather than the original method, the generic wrapper procedure redirects the call to the original method.

We claim:

1. A method for adding at least a Java compiler to an integrated development environment (IDE), wherein the method enables a programmer to develop a software application written in any programming language supported by the IDE and to execute the software application on at least a Java runtime environment, wherein the Java compiler is capable of compiling Microsoft intermediate language (MSIL) bytecodes into Java bytecodes, the method comprising:
a) entering a deployment programming language and a source programming language of the software application;
b) replacing each original deployment function of the IDE with a new deployment function of the Java compiler; and,
c) building the software application.

2. The method of claim 1, further comprising:
d) entering a reference to an external file;
e) converting said external file to an assembly file; and,
f) replacing said reference to said external file with a reference to said assembly file.

3. The method of claim 2, further comprising:
g) referencing to at least a namespace of the Java runtime environment; and,
h) setting properties of the Java compiler.

4. The method of claim 3, wherein said namespace is used to display public program components.

5. The method of claim 1, wherein said deployment function is used to do at least one of the following: build; compile; execute; run; and debug the software application.

6. The method of claim 1, wherein the IDE is at least the Microsoft Visual Studio for .Net, which includes a COM interface having a plurality of functions.

7. The method of claim 6, wherein the source programming language is at least one of: C++ with managed extensions; C# (C-Sharp); Visual Basic .Net; Pascal; Cobol; Java; Jscript; and J# (J-Sharp).

8. The method of claim 2, wherein said assembly file can be executed on a .Net platform.

9. The method of claim 8, wherein said external file is at least one of: a Java reference file; an enterprise Java beans (EJB) object; and a component object model (COM) object.

10. The method of claim 6, wherein replacing said original deployment function is performed by implementing the COM interface's functions, wherein said COM interface includes said original deployment function of said Microsoft Visual Studio for .Net.

11. The method of claim 10, wherein the following steps comprise implementing said COM interface's functions:
a) determining the location of said original deployment function in a virtual table;
b) terminating execution if said COM interface is wrapped by a wrapper object,
c) allocating a new wrapper object if said COM interface is not wrapped by a wrapper object;
d) saving an address of said new wrapper object in a global wrapper table (GWT);
e) saving an address of said COM interface in a reference list;
f) terminating execution if said original deployment function is already replaced by said new deployment function;
g) saving a pointer to said new deployment function in said GWT; and,
h) executing said new deployment function.

12. The method of claim 11, wherein said virtual table is a data structure comprising at least: pointers to said COM interfaces; and pointers to said original deployment function implemented by said COM interfaces.

13. The method of claim 11, wherein said virtual table is associated with a single COM object.

14. The method of claim 11, wherein said GWT is a data structure comprising at least: said wrapper object's address; and a pointer to said new deployment function.

15. The method of claim 11, wherein said reference list is a data structure comprising at least: the address of each wrapped COM interface.

16. The method of claim 11, further comprising saving said virtual table in a global table.

17. The method of claim 11, further comprising generating an error message prior to said method termination.

18. The method of claim 11, wherein executing said new deployment function further comprises:
a) replacing said COM interface's address with said wrapper object's address in a stack; and,
b) jumping to an address pointed by said new deployment function's pointer.

19. The method of claim 16, wherein said new deployment function is capable of executing said original deployment function.

20. The method of claim 19, wherein the following steps comprise executing said original deployment function by said new deployment function:
a) retrieving said COM interface's address from said reference list;
b) retrieving said original deployment function's address from said global table; and,
c) jumping to said address of said original deployment function.

21. The method of claim 1, wherein said MSIL is generated using at least a .Net compiler.

22. The method of claim 21, wherein said .Net compiler is capable of compiling at least one of the following programming languages: C++ with managed extensions; C#; Visual Basic; Pascal; Cobol; Java; J#; and Jscript.

23. The method of claim 1, wherein said generated Java bytecodes can operate in conjunction with any Java runtime environment.

24. The method of claim 23, wherein said Java runtime environment comprises at least Java to enterprise edition (J2EE) platform and Java to standard edition (J2SE) platform.

25. A computer executable code for adding at least a Java compiler to an integrated development environment (IDE), wherein the code enables a programmer to develop a software application written in any programming language supported by the IDE and to execute the software application on at least a Java runtime environment, wherein the Java compiler is capable of compiling Microsoft intermediate language (MSIL) bytecodes into Java bytecodes, the code comprising the steps of:
a) entering a deployment programming language and a source programming language of the software application;
b) replacing each original deployment function of the IDE with a new deployment function of the Java compiler; and,
c) building the software application.

26. The computer executable code of claim 25, further comprising the steps of:
d) entering a reference to an external file;
e) converting said external file to an assembly file; and,
f) replacing said reference to said external file with a reference to said assembly file.

27. The computer executable code of claim 26, further comprising the steps of:
g) referencing to at least a namespace of the Java runtime environment; and,
h) setting the properties page of the Java complier.

28. The computer executable code of claim 27, wherein said namespace is used to display public program components.

29. The computer executable code of claim 25, wherein said deployment function is used to do at least one of the following: build; compile; execute; run; and debug the software application.

30. The computer executable code of claim 25, wherein the IDE is at least the Microsoft Visual Studio for .Net, which includes a COM interface having a plurality of functions.

31. The computer executable code of claim 30, wherein said source programming language is at least one of: C++ with managed extensions; C# (C-Sharp); Visual Basic .Net; Pascal; Cobol; Java; Jscript; and J# (J-Sharp).

32. The computer executable code of claim 26, wherein said assembly file can be executed on a .Net platform.

33. The computer executable code of claim 32, wherein said external file is at least one of: a Java reference file, an enterprise Java beans (EJB) object, a component object model (COM) object.

34. The computer executable code of claim 30, wherein replacing said original deployment function is performed by implementing the COM interface's functions, wherein said COM interface implements said original deployment functions of said Microsoft Visual Studio for .Net.

35. The computer executable code of claim 34, wherein the following steps comprise implementing said COM interface's function interface:
a) determining the location of said original deployment function in a virtual table;
b) terminating execution if said COM interface is already wrapped by a wrapper object;
c) allocating a new wrapper object if said COM interface is not already wrapped by a wrapper object;
d) saving an address of said new wrapper object in a global wrapper table (GWT);
e) saving an address of said COM interface in a reference list;
f) terminating execution if said original deployment function is already replaced by said new deployment function;
g) saving a pointer to said new deployment function in said GWT; and,
h) executing said new deployment function.

36. The computer executable code of claim 35, wherein said virtual table is a data structure comprising at least: pointers to said COM interfaces; and pointers to said original deployment functions implemented by said COM interfaces.

37. The computer executable code of claim 35, wherein said virtual table is associated with a single COM object.

38. The computer executable code of claim 35, wherein said GWT is a data structure comprising at least: said wrapper object's address and a pointer to said new deployment function.

39. The computer executable code of claim 35, wherein said reference list is a data structure comprising at least: the address of each wrapped COM interface.

40. The computer executable code of claim 35, further comprising the step of saving said virtual table in a global table.

41. The computer executable code of claim 35, further comprising the step of:
generating an error message prior to said execution termination.

42. The computer executable code of claim 35, wherein executing said new deployment function further comprises the steps of:
a) replacing said COM interface's address with said wrapper object's address in a stack; and,
b) jumping to an address pointed by said new deployment function's pointer.

43. The computer executable code of claim 40, wherein said new deployment function is capable of executing said original deployment function.

44. The computer executable code of claim 43, wherein the following steps comprise executing said original deployment function by said new deployment function:
a) retrieving said COM interface's address from said reference list;
b) retrieving said original deployment function's address from said global table; and,
c) jumping to said address of said original deployment function.

45. The computer executable code of claim 25, wherein said MSIL is generated using at least a .Net compiler.

46. The computer executable code of claim 45, wherein said .Net compiler is capable of compiling at least one of the following programming languages: C++ with managed extensions; C#; Visual Basic; Pascal; Cobol; Java; J#; and Jscript.

47. The computer executable code of claim 25, wherein said generated Java bytecodes can operate in conjunction with any Java runtime environment.

48. The computer executable code of claim 47, wherein said Java runtime environment comprises at least Java to enterprise edition (J2EE) platform and Java to standard edition (J2SE) platform.

49. An integrated development environment (IDE) capable of creating a software application, the IDE comprising a method for implementing functions of a component object model (COM) interface by a third party application, wherein the method is operative to replace an original function of the COM interface with a new function of the third party application, the method comprises the steps of:
a) determining the location of the original function in a virtual table;
b) terminating execution if the COM interface is already wrapped by a wrapper object;
c) allocating a new wrapper object if the COM interface is not already wrapped by a wrapper object;
d) saving an address of said new wrapper object in a global wrapper table (GWT);
e) saving an address of said COM interface in a reference list;
f) terminating execution if said original function is already replaced by said new function;
g) saving a pointer to said new function in said GWT; and,
h) executing said new function.

50. The method of claim 49, wherein said virtual table is a data structure comprising at least: a pointer to the COM interface; and a pointer to the original deployment function implemented by the COM interface.

51. The method of claim 49, wherein said virtual table is associated with a single COM object.

52. The method of claim 49, wherein said GWT is a data structure comprising at least: said wrapper object's address; and a pointer to the new deployment function.

53. The method of claim 49, wherein said reference list is a data structure comprising at least: the address of each wrapped COM interface.

54. The method of claim 49, further comprising the step of: saving said virtual table in a global table.

55. The method of claim 49, further comprising the step of generating an error message prior to said method termination.

56. The method of claim 49, wherein executing said new function further comprises the steps of:
a) replacing said COM interface's address with said wrapper object's address in a stack; and,
b) jumping to an address pointed by the new deployment function's pointer.

57. The method of claim 54, wherein the new function is capable of executing the original function.

58. The method of claim 57, wherein the following steps comprise executing the original deployment function by the new deployment function:
a) retrieving said COM interface's address from said reference list;
b) retrieving said original deployment function's address from said global table;
and,
c) jumping to said address of the original function.

59. The method of claim 49, wherein the third party application is at least a Java compiler.

60. The method of claim 59, wherein the Java compiler is capable of compiling Microsoft intermediate language (MSIL) bytecodes into Java bytecodes.

61. The method of claim 60, wherein the MSIL is generated using at least a .Net compiler.

62. The method of claim 49, wherein the IDE is at least the Microsoft Visual Studio for .Net.

63. An integrated development environment (IDE) capable of creating a software application, the IDE further comprising a computer executable code for implementing functions of component object model (COM) interface by a third party application, wherein the code is operative to replace an original function of the COM interface with a new function of the third party application, the code comprises the steps of:
a) determining the location of the original function in a virtual table;
b) terminating execution if the COM interface is already wrapped by a wrapper object;
c) allocating a new wrapper object if the COM interface is not already wrapped by a wrapper object;
d) saving an address of a wrapper object in a global wrapper table (GWT);
e) saving an address of the COM interface in a reference list;
f) terminating execution if the original function is already replaced by the new function;
g) saving a pointer to the new function in the GWT; and,
h) executing the new function.

64. The computer executable code of claim 63, wherein said virtual table is a data structure comprising at least: a pointer to the COM interface; and a pointer to the original deployment function implemented by the COM interface.

65. The computer executable code of claim 63, wherein said virtual table is associated with a single COM object.

66. The computer executable code of claim 63, wherein said GWT is a data structure comprising at least: said wrapper object's address; and a pointer to the new deployment function.

67. The computer executable code of claim 63, wherein said reference list is a data structure comprising at least said address of each said wrapped COM interface.

68. The computer executable code of claim 63, further comprising the step of: saving said virtual table in a global table.

69. The computer executable code of claim 63, further comprising the step of generating an error message prior to said method termination.

70. The computer executable code of claim 63, wherein executing said new function further comprises the steps of:
a) replacing said COM interface's address with said wrapper object's address in a stack; and,
b) jumping to an address pointed by the new deployment function's pointer.

71. The computer executable code of claim 63, wherein the new function is capable of executing the original function.

72. The computer executable code of claim 63, wherein the following steps comprise executing the original deployment function by the new deployment function:
a) retrieving the COM interface's address from said reference list;
b) retrieving the original deployment function's address from the global table; and,
c) jumping to said address of the original function.

73. The computer executable code of claim 63, wherein the third party application is at least a Java compiler.

74. The computer executable code of claim 73, wherein said Java compiler is capable of compiling Microsoft intermediate language (MSIL) bytecodes into Java bytecodes.

75. The computer executable code of claim 74, wherein the MSIL is generated using at least a .Net compiler.

76. The computer executable code of claim 63, wherein the IDE is at least the Microsoft Visual Studio for .Net.
